(19) United States
(12) Patent Application Publication
(10) Pub. No.: US 2025/0278938 A1
(43) Pub. Date: Sep. 4, 2025

(54) IMAGE PROCESSING APPARATUS AND IMAGE PROCESSING METHOD

(71) Applicant: CANON KABUSHIKI KAISHA, Tokyo (JP)

(72) Inventor: KYOSUKE TAKAHASHI, Kanagawa (JP)

(21) Appl. No.: 19/051,516

(22) Filed: Feb. 12, 2025

(30) Foreign Application Priority Data
Feb. 29, 2024 (JP) 2024-030637

(51) Int. Cl. G06V 20/40; G06V 10/82

(52) U.S. Cl. CPC G06V 20/42; G06V 10/82

(57) ABSTRACT

An image processing apparatus obtains image data of one frame including a plurality of subjects moving in a specific direction and inputs the image data to a trained machine-learning model. The apparatus, based on evaluation values output by the trained machine-learning model, determines rankings of the plurality of subjects in the specific direction. The apparatus then executes, based on a result of the determination, processing for tracking a subject of a specific ranking. The trained machine-learning model outputs, for each of areas of the plurality of subjects, an evaluation value that increases or decreases as the ranking is closer to the specific ranking.

### BACKGROUND OF THE INVENTION

### Field of the Invention

The present invention relates to an image processing apparatus and an image processing method, and especially to a technique to estimate a positional relationship among a plurality of subjects.

### Description of the Related Art

When capturing a scene where a plurality of subjects move in similar directions, such as track and field and a race, there are times when it is desired to track a subject at a specific position (e.g., the lead), rather than a specific subject. In view of this, the specification of US-2020-0401793 proposes a method of specifying a positional relationship among subjects by detecting three-dimensional positions of characteristic parts (heads, joints, and the like) of the subjects with use of images obtained by capturing the same subjects from a plurality of different directions. Also, Japanese Patent Laid-Open No. 2022-022767 proposes a method in which a leading subject is detected based on a moving direction among a plurality of subjects moving in the same direction.

With the method of the specification of US-2020-0401793, it is necessary to detect joints of a subject from images obtained by capturing the same human subject using a plurality of image capturing apparatuses. Therefore, a leading subject cannot be detected based on an image of one frame captured by one image capturing apparatus. Japanese Patent Laid-Open No. 2022-022767 also requires a plurality of images to detect a moving direction of subjects.

### SUMMARY OF THE INVENTION

An aspect of the present invention provides an image processing apparatus and an image processing method capable of estimating, from an image of one frame, a subject of a specific ranking, such as a leading subject, among a plurality of subjects included in the image with high precision.

According to an aspect of the present invention, there is provided an image processing apparatus, comprising: one or more processors, wherein the one or more processors execute a program stored in a memory and thereby perform a method comprising: obtaining image data of one frame including a plurality of subjects moving in a specific direction; inputting the image data to a trained machine-learning model; based on evaluation values output by the trained machine-learning model, determining rankings of the plurality of subjects in the specific direction; and based on a result of the determination, executing processing for tracking a subject of a specific ranking, and wherein for each of areas of the plurality of subjects, the trained machine-learning model outputs an evaluation value that increases or decreases as the ranking is closer to the specific ranking.

According to another aspect of the present invention, there is provided an image capturing apparatus, comprising: one or more processors, wherein the one or more processors execute a program stored in a memory and thereby perform a method comprising: generating image data of one frame with use of an image sensor; inputting the image data to a trained machine-learning model; based on evaluation values output by the trained machine-learning model, detecting a subject of a specific ranking from among a plurality of subjects included in the image data; and setting a focus detection area at the detected subject of the specific ranking.

According to a further aspect of the present invention, there is provided an image processing method executed by an image processing apparatus, the image processing method comprising: obtaining image data of one frame including a plurality of subjects moving in a specific direction; inputting the image data to a trained machine-learning model; based on evaluation values output by the trained machine-learning model, determining rankings of the plurality of subjects in the specific direction; and based on a result of the determination, executing processing for tracking a subject of a specific ranking, wherein for each of areas of the plurality of subjects, the trained machine-learning model outputs an evaluation value that increases or decreases as the ranking is closer to the specific ranking.

According to another aspect of the present invention, there is provided a non-transitory computer-readable medium storing a program which, when executed by a computer, causes the computer to perform an image processing method comprising: obtaining image data of one frame including a plurality of subjects moving in a specific direction; inputting the image data to a trained machine-learning model; based on evaluation values output by the trained machine-learning model, determining rankings of the plurality of subjects in the specific direction; and based on a result of the determination, executing processing for tracking a subject of a specific ranking, wherein for each of areas of the plurality of subjects, the trained machine-learning model outputs an evaluation value that increases or decreases as the ranking is closer to the specific ranking.

Further features of the present invention will become apparent from the following description of exemplary embodiments with reference to the attached drawings.

### BRIEF DESCRIPTION OF THE DRAWINGS

FIG. 1 is a block diagram showing an exemplary functional configuration of a digital camera as one example of an image processing apparatus according to an embodiment.

FIG. 2 is a flowchart related to operations of an object detection unit according to an embodiment.

FIG. 3 is a flowchart related to operations of the object detection unit according to an embodiment.

FIG. 4 is a block diagram showing an exemplary configuration of the object detection unit according to an embodiment.

FIG. 5 is a block diagram showing another exemplary configuration of the object detection unit according to an embodiment.

FIGS. 6A and 6B are diagrams showing examples of an input image according to an embodiment.

FIGS. 7A and 7B are diagrams showing examples of an image input to a NN and a heat map output by the NN according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that the following describes a mode in which the present invention is implemented on a digital camera as one example of an image processing apparatus. However, image capturing functions are not indispensable in the present invention, and the present invention can be implemented on any electronic devices including one or more computation circuits or processors. Such electronic devices include a video camera, a computer device (a personal computer, a tablet computer, a media player, a PDA, or the like), a smartphone, a smartwatch, a game device, a robot, a drone, and a driving recorder. These are examples, and the present invention can also be implemented on other electronic devices.

### (Configuration of Digital Camera)

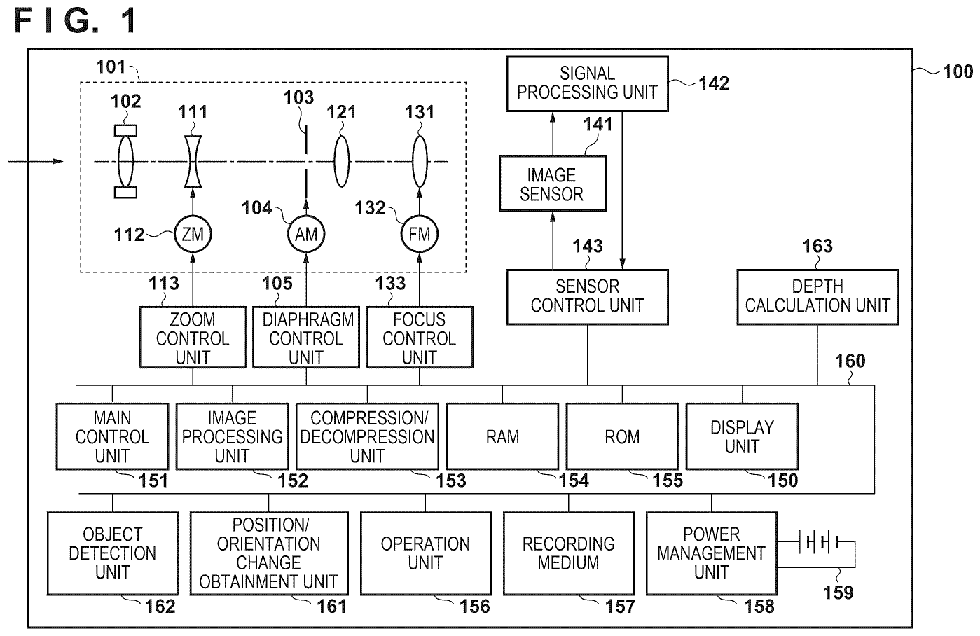

FIG. 1 is a block diagram showing an exemplary functional configuration of a digital camera 100 (hereinafter simply referred to as a camera 100) according to an embodiment of the invention. The camera 100 is capable of capturing and recording moving images and still images. Discrete functional blocks inside the camera 100 are connected in such a manner that they can communicate with one another via a bus 160. The operations of the camera 100 are realized as a result of one or more programmable processors included in a main control unit 151 controlling each functional block by reading a program stored in, for example, a ROM 155 into a RAM 154 and executing the program.

Note that each functional block of the camera 100 can be implemented by software, or by a combination of software and hardware, except for components that can obviously be realized only by hardware (e.g., imaging lenses 101, an image sensor 141, and the like). For example, the functional blocks may be realized by dedicated hardware, such as an application-specific IC (ASIC). Also, the functional blocks may be realized by a processor, such as a CPU, executing a program stored in a memory. Note that a plurality of functional blocks may be realized by the same constituent (e.g., one ASIC). Furthermore, hardware that realizes a part of functions of a certain functional block may be included in hardware that realizes another functional block.

The imaging lenses 101 (a lens unit) include a first lens group 102, a zoom lens 111, a diaphragm 103, a third lens group 121, a focus lens 131, a zoom motor (ZM) 112, a diaphragm motor (AM) 104, and a focus motor (FM) 132. The first lens group 102, zoom lens 111, diaphragm 103, third lens group 121, and focus lens 131 compose an imaging optical system. The first lens group 102 and the third lens group 121 are fixed lenses, whereas the zoom lens 111 and the focus lens 131 are movable lenses. Note, although illustrated as a single lens, each of the lenses 102, 111, 121, and 131 can be composed of a plurality of lenses. Also, the imaging lenses 101 may be configured as interchangeable lenses detachable from the camera 100.

A diaphragm control unit 105 changes an aperture diameter of the diaphragm 103 by controlling the operations of the diaphragm motor 104 in accordance with a command from the main control unit 151.

A zoom control unit 113 changes the focal length (angle of view) of the imaging lenses 101 by controlling the operations of the zoom motor 112 in accordance with a command from the main control unit 151.

A focus control unit 133 converts defocus amounts calculated by a depth calculation unit 163 into a driving amount and a driving direction of the focus motor 132. Based on these driving amount and driving direction, the focus control unit 133 controls the operations of the focus motor 132 and drives the focus lens 131, thereby controlling a focus state of the imaging lenses 101.

Here, the focus control unit 133 performs automatic focus detection (AF) of a phase-difference detection method; however, the focus control unit 133 may execute AF of a contrast detection method that is based on contrast evaluation values of image signals obtained from the image sensor 141.

The image sensor 141 may be, for example, a known CCD or CMOS color image sensor that includes color filters based on the primary-color Bayer array. The image sensor 141 includes a pixel array in which a plurality of pixels are arrayed two-dimensionally, and peripheral circuits for reading out signals from each pixel. Each pixel accumulates charges corresponding to the amount of incident light through photoelectric conversion. A signal with a voltage corresponding to the amount of charges accumulated during an exposure period is read out from each pixel; as a result, a pixel signal group (analog image signals) representing a subject image formed by the imaging lenses 101 on an image plane, which is formed on an image-forming plane of the image sensor 141, is obtained. A sensor control unit 143 controls readout of the analog image signals from the image sensor 141 in accordance with an instruction from the main control unit 151.

The image signals read out from the image sensor 141 are supplied to a signal processing unit 142. The signal processing unit 142 applies such signal processing as noise reduction processing, A/D conversion processing, and automatic gain control processing to the analog image signals read out from the image sensor 141, and outputs the resultant signals to the sensor control unit 143 as image data. The sensor control unit 143 accumulates the image data received from the signal processing unit 142 in the RAM 154.

When recording the image data stored in the RAM 154, the main control unit 151 generates a data file corresponding to a recording format by, for example, adding a predetermined header and the like to the image data. At this time, the main control unit 151 encodes the image data in a compression/decompression unit 153 as necessary, and stores the encoded image data into the data file. The main control unit 151 records the generated data file in a recording medium 157, such as a memory card, for example.

Furthermore, when displaying the image data stored in the RAM 154, the main control unit 151 scales the image data in an image processing unit 152 so that the image data conforms to a display size on a display unit 150, and then writes the image data to an area which is included in the RAM 154 and which is used as a video memory (a VRAM area). The display unit 150 reads out image data for display from the VRAM area in the RAM 154, and displays the image data on, for example, a display apparatus, such as an LCD and an organic EL display. The display unit 150 also displays a detection result of a main subject detected by an object detection unit 162 (e.g., a frame indicating a main subject area).

When capturing moving images (during a capture standby state or recording of moving images), the camera 100 displays the captured moving images on the display unit 150 in real time, thereby causing the display unit 150 to function as an electronic viewfinder (EVF). Moving images and frame images thereof that are displayed when causing the display unit 150 to function as the EVF are referred to as live-view images or through-the-lens images. Furthermore, in a case where the camera 100 has captured a still image, it displays the still image that has been captured most recently on the display unit 150 for a certain time period so that a user can check the capture result. These display operations are also realized through control performed by the main control unit 151.

The compression/decompression unit 153 encodes and decodes image data. For example, in a case where still images and moving images are recorded, image data and sound data are encoded using a predetermined encoding method. Furthermore, when reproducing a still image data file and a moving image data file recorded in the recording medium 157, the compression/decompression unit 153 decodes the encoded data and stores the resultant data into the RAM 154.

The RAM 154 is used as, for example, a system memory for executing programs, a video memory, and a buffer memory.

The ROM 155 stores programs executable by a processor of the main control unit 151, various types of setting values, unique information of the camera 100, GUI data, and the like. The ROM 155 may be electrically rewritable.

An operation unit 156 is a general term for a group of input devices for the user to input instructions to the camera 100, such as switches, buttons, keys, and a touch panel. An input made via the operation unit 156 is detected by the main control unit 151 via the bus 160, and the main control unit 151 controls each component to realize an operation corresponding to the input.

The main control unit 151 includes, for example, one or more programmable processors, such as CPUs and MPUs, and controls each component by, for example, reading a program stored in the ROM 155 into the RAM 154 and executing the program, thereby realizing the functions of the camera 100. The main control unit 151 also executes AE processing for automatically determining exposure conditions (a shutter speed or an accumulation time period, an F-number, and sensitivity) on the basis of information of subject luminance. The information of subject luminance can be obtained from, for example, the image processing unit 152. The main control unit 151 can also determine exposure conditions on the basis of luminance information of an area of a specific subject, such as a human face, for example.

When capturing moving images, the main control unit 151 keeps the diaphragm 103 fixed, and controls exposure by means of an electronic shutter speed (an accumulation time period) and a magnitude of a gain. The main control unit 151 notifies the sensor control unit 143 of the determined accumulation time period and magnitude of the gain. The sensor control unit 143 controls the operations of the image sensor 141 so that image capture conforming to the notified exposure conditions is performed.

The image processing unit 152 applies predetermined image processing to image data accumulated in the RAM 154. The image processing applied by the image processing unit 152 can include, for example, color interpolation processing, correction processing, detection processing, data processing, evaluation value calculation processing, special effects processing, and so forth.

The color interpolation processing is processing which is executed in a case where the image sensor is provided with color filters, and which interpolates values of color components that are not included in the individual pieces of pixel data composing image data. The color interpolation processing is also called demosaicing processing.

The correction processing can include such processing as white balance adjustment, tone correction, correction of image degradation caused by optical aberration of an imaging lenses 101 (image recovery), correction of the influence of vignetting of the imaging lenses 101, and color correction.

The detection processing can include detection of a characteristic area (e.g., a face or head area, or a human body area) and a motion therein, processing for recognition of a person, and so forth.

The data processing can include such processing as cutout of an area (cropping), composition, and scaling. The data processing also includes generation of image data for display and image data for recording.

The evaluation value calculation processing can include such processing as generation of evaluation values used in automatic exposure control (AE). The image processing unit 152 may calculate defocus amounts in place of the depth calculation unit 163.

The special effects processing can include such processing as addition of blur effects, alteration of shades of colors, relighting, and so forth.

Note that these are examples of processing that can be applied by the image processing unit 152, and are not intended to limit processing applied by the image processing unit 152.

Information related to an area of a main subject selected by the main control unit 151 may be used in image processing in the image processing unit 152 (e.g., white balance adjustment processing, processing for generating luminance information of a subject, and so forth). Note that in a case where the focus control unit 133 performs AF of a contrast detection method, the image processing unit 152 can generate contrast evaluation values and supply them to the focus control unit 133. The image processing unit 152 stores processed image data, information related to a detected feature area, and the like into the RAM 154.

A position/orientation change obtainment unit 161 is composed of, for example, an orientation sensor, such as a gyroscope, an acceleration sensor, and an electronic compass, and measures changes in the position and orientation of the camera 100. In the present embodiment, as one example, the angular velocities around the yaw axis and the pitch axis are detected as orientation changes under the assumption that the optical axis of the imaging lenses 101 is the roll axis, the axis that is perpendicular to the roll axis and parallel to the longitudinal direction of the image sensor is the pitch axis, and the axis perpendicular to the roll axis and the pitch axis is the yaw axis. The position/orientation change obtainment unit 161 stores information indicating detected changes in the position/orientation into the RAM 154. The information indicating the changes in the position/orientation detected by the position/orientation change obtainment unit 161 can be referred to by the image processing unit 152 and the like.

The object detection unit 162 infers rankings of predetermined objects (which are assumed here to be human heads) existing in an image from image data of one frame (e.g., image data for display). Then, based on the inference result, the object detection unit 162 selects one area as an area of a main subject from the image. The object detection unit 162 stores information of the selected area of the main subject into the RAM 154.

In the present embodiment, the object detection unit 162 executes the inference with use of a trained machine-learning model that uses a neural network (NN). The object detection unit 162 can include a hardware circuit for executing computation of the neural network at high speed. Examples of such a hardware circuit include a graphics processing unit (GPU), a neural processing unit (NPU), a field-programmable gate array (FPGA), and an ASIC. Also, a parameter set for realizing the trained machine-learning model can be stored in the ROM 155, for example. Note that examples of the neural network include a convolutional neural network (CNN) and a recurrent neural network.

As will be described later, the form of the output result of the NN used in the object detection unit 162 can vary depending on the training method. However, it is assumed that, for each of the areas of the predetermined objects within an input two-dimensional image, the NN outputs an evaluation value (also referred to as a priority, a likelihood, or a score) that increases or decreases as the certainty of being at the leading position increases.

Based on the output from the object detection unit 162, the main control unit 151 can set a focus detection area at an area with the highest likelihood or score. This enables tracking and image capture where the leading subject is focused even when the leading person has changed. Note that a subject ranked nth from the lead can be tracked and captured by setting the focus detection area at an area with the nth priority (where n is an integer equal to or larger than 2). The main control unit 151 stores information of an area at which the focus detection area has been set into the RAM 154 as information of a main subject area. The information of the main subject area is used in, for example, processing of the image processing unit 152.

Note that the main control unit 151 may control related functional blocks so that captured image data, the detection result of the object detection unit 162, and the detection result of the position/orientation change obtainment unit 161 in the latest predetermined period are held in the RAM 154.

The main control unit 151 can also display the detection result of the object detection unit 162. For example, based on the output result of the object detection unit 162, the main control unit 151 may display frame-like indicators indicating the areas of the predetermined objects and corresponding rankings in such a manner that they are superimposed on image data used in the detection.

The depth calculation unit 163 calculates defocus amounts in an arbitrary area within an image with use of any known method. The depth calculation unit 163 can calculate defocus amounts on the basis of, for example, a phase difference between a pair of signals for focus detection obtained from the image sensor 141. Alternatively, the depth calculation unit 163 may calculate defocus amounts on the basis of a phase difference between a pair of signals for focus detection obtained from an AF sensor provided separately from the image sensor 141. It is assumed that a defocus direction is indicated by the sign of defocus amounts.

The depth calculation unit 163 may calculate defocus amounts with respect to one focus detection area set by the main control unit 151, or may calculate defocus amounts for each of areas obtained by dividing the entire image in the horizontal and vertical directions. Information indicating the distribution of defocus amounts throughout the entire image is also referred to as a defocus map. The defocus amounts calculated by the depth calculation unit 163 and information of a corresponding area are stored in the RAM 154, and can be referred to by the focus control unit 133, the image processing unit 152, and the like.

### (Operations of Object Detection Unit 162)

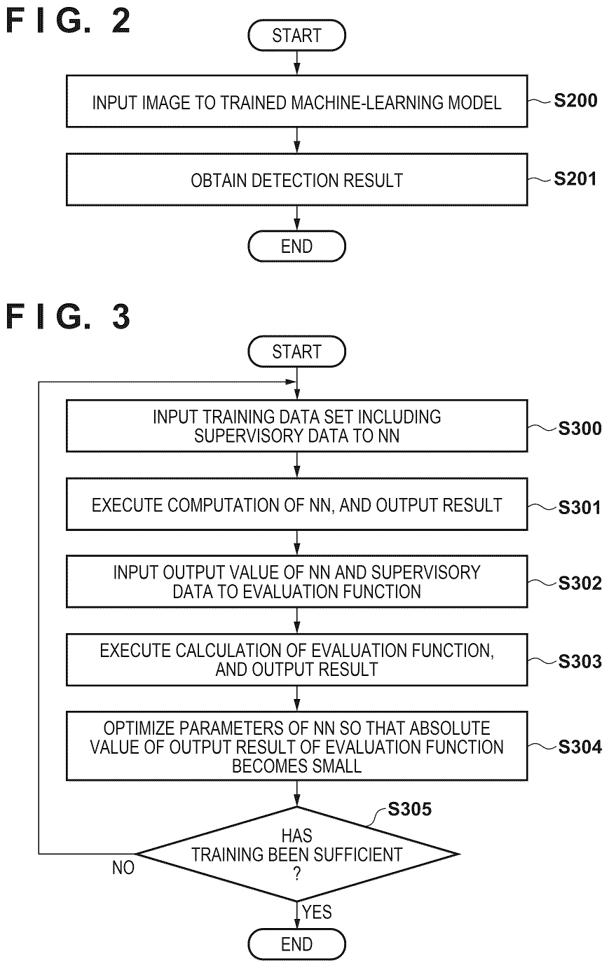

The operations of the object detection unit 162 will be described using a flowchart of FIG. 2.

In step S200, the object detection unit 162 inputs image data to a trained machine-learning model. The image data input to the trained machine-learning model is two-dimensional image data, and may be, for example, image data for display generated by the image processing unit 152. The image data for display may be input to the trained machine-learning model after applying preprocessing, such as reduction processing, thereto.

Furthermore, information of rectangular areas in which specific objects exist within the two-dimensional image data can also be input to the trained machine-learning model, together with this two-dimensional image data. In this case, it is possible to use information of areas of the specific objects that have been detected as characteristic areas by the image processing unit 152.

In step S201, the object detection unit 162 obtains a detection result from the trained machine-learning model. As described above, the form of the detection result varies depending on the training method of the trained machine-learning model. However, for each area in which the existence of the predetermined object is estimated, an evaluation value (also referred to as a likelihood or a score) that increases or decreases as the predetermined object becomes closer to the leading position is obtained. The object detection unit 162 stores the obtained detection result into the RAM 154.

A general training method of a NN will be described using FIG. 3. First, a data set for training, which is composed of a pair of input data to the NN and supervisory data indicating a desired output result for the input data, is prepared. It is assumed here that the input data is two-dimensional image data, or a combination of two-dimensional image data and information indicating areas of specific objects. For example, information indicating an area of a specific object may be, but is not limited to, the coordinates of two vertices representing opposing corners of a rectangular area in which the area of the specific object is inscribed, or the coordinates of one vertex of the rectangular area and the sizes of the area in the horizontal and vertical directions.

The input data may be a live-action image, or may be a computer-graphics (CG) image. The form of the prepared supervisory data is the same as the form of the output of the NN. For example, in a case where the NN outputs a two-dimensional map of evaluation values or scores, a map of ground truth evaluation values or scores is prepared. Furthermore, in a case where evaluation values or scores of the respective areas of the specific objects are output, ground truth evaluation values or scores are prepared.

Note that although the main control unit 151 or the object detection unit 162 may execute training of the NN, as a large amount of computation is required in the training, it is realistic to execute the training on an external apparatus with a greater processing ability. For the sake of convenience, the following description is provided under the assumption that the object detection unit 162 mainly executes the training.

In step S300, the object detection unit 162 inputs the input data of the data set for training to the NN.

In step S301, the object detection unit 162 executes computation of the NN, and stores the result thereof into, for example, the RAM 154.

In step S302, the object detection unit 162 inputs the result obtained in step S301 and supervisory data corresponding to the input data to a predetermined evaluation function.

In step S303, the object detection unit 162 executes calculation of the evaluation function, and stores the result thereof into, for example, the RAM 154.

In step S304, the object detection unit 162 changes parameters of the NN so that the absolute value of the result of calculation of the evaluation function becomes small. This change can be made by using a known optimization algorithm, such as a gradient change method.

In step S305, the object detection unit 162 determines whether the training has been sufficient; the training is ended if it has been determined that the training has been sufficient, and processing is executed repeatedly from step S300 if it has not been thus determined. The object detection unit 162 determines that the training has been sufficient in a case where a predetermined convergence condition is satisfied, such as a case where the absolute value of the change in the result of calculation of the evaluation function obtained in step S303 is smaller than a threshold, and a case where the accuracy of the output of the NN is equal to or higher than a threshold, for example.

Note that although parameters are changed per sample (one pair of input data and supervisory data) of the data for training in the illustration of FIG. 3, parameters may be changed based on the result of calculation of the evaluation function for a plurality of samples.

In view of the general training method described above, the following describes a training method of the NN according to the present embodiment.

In the present embodiment, image data of a competition in which a plurality of runners (subjects) run on a course (sprinting or middle- or long-distance running, relay, racewalking, marathon, road running, etc.) is used as input data included in a data set for training. Also, it is assumed that supervisory data is the positions of head areas of runners included in the input data and the rankings of the runners. It is assumed that a position of a head area is the image coordinates of the center (the intersection of diagonals) of a rectangle in which the head area is inscribed, and the sizes (the number of pixels) of the rectangle in the horizontal and vertical directions.

The NN outputs candidates for head areas, and priorities or scores of the respective candidates. A priority or a score is a value which increases or decreases as the ranking of the head area is closer to the lead, and which is in a range equal to or larger than 0 and equal to or smaller than 1, for example. The candidates for the head areas and the priorities or scores may be obtained from the same layer or different layers among a plurality of layers composing the NN.

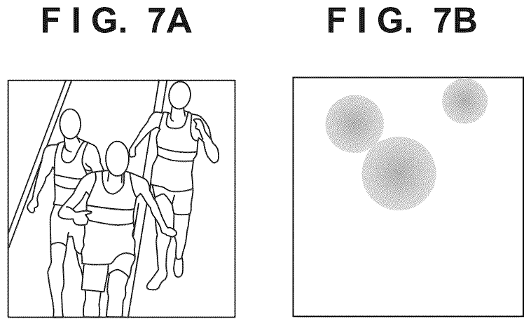

The NN can be configured to output the priorities or scores corresponding to the head areas in any form. For example, the NN can be configured to output a two-dimensional distribution of scores corresponding to the input image as a heat map, or configured to output one score per head area. In a case where the NN is configured to output scores as a heat map, it is possible to use supervisory data that indicates, for each head area, a Gaussian distribution of scores corresponding to this head area, with the center of mass representing a peak. In this case, a score corresponding to the peak can be a fixed value corresponding to the ranking. FIGS. 7A and 7B show examples of the input image and the heat map of scores output by the NN.

In a case where the NN outputs the heat map of scores, the main control unit 151 selects a head area including a pixel position with the largest value in the heat map, and sets a focus detection area at this head area, for example. Furthermore, in a case where the NN outputs information of the head areas and corresponding scores separately, the main control unit 151 selects a head area with the highest score, and sets a focus detection area at this head area, for example.

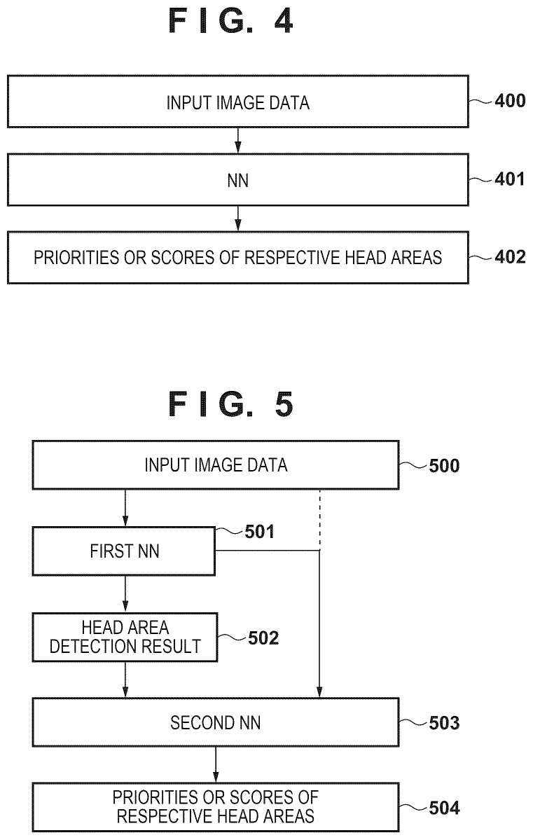

FIG. 4 shows an example of a configuration that obtains candidates for head areas and priorities or scores 402 of the respective candidates from the same layer (e.g., an output layer) of a NN 401 with respect to input image data 400.

Also, FIG. 5 shows an example of a configuration in which a first NN 501 detects candidates for head areas from input image data, and a second NN 503 calculates priorities or scores of the respective candidates for the head areas with use of a detection result of the first NN 501. In the case of the configuration of FIG. 5, information of the head areas can be obtained from the first NN 501, whereas corresponding scores can be obtained from the second NN 503 in the form of numerical values or a heat map.

The present embodiment causes an evaluation function used in training of the NN to output a value that takes into account the rankings of subjects, thereby realizing training where a subject of a specific ranking is detected with high precision. Specifically, for each of the candidates for head areas, a priority or a score that increases or decreases in value as the ranking is closer to the lead is calculated, and a loss increases as a difference from the value of supervisory data increases. At this time, a head area closer to the lead in the supervisory data has a larger loss relative to the magnitude of the difference.

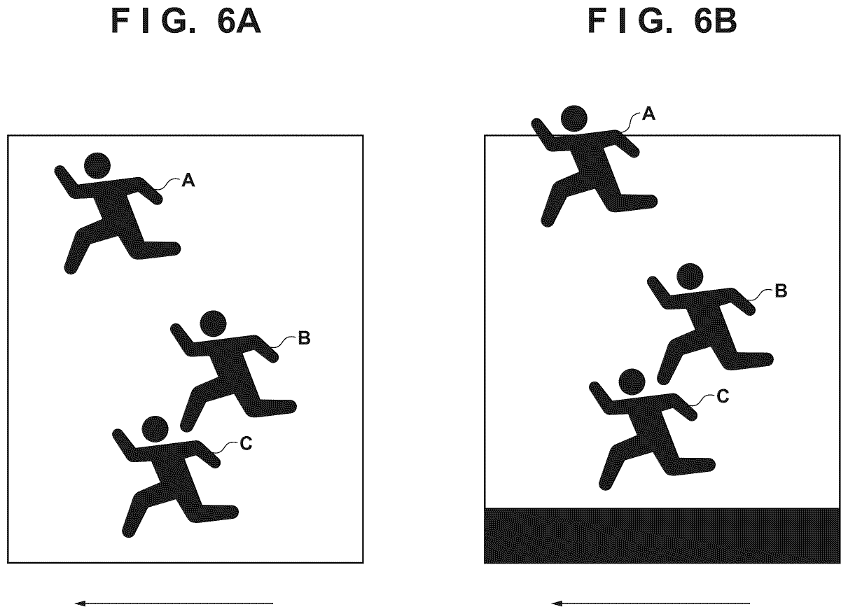

Assume a scene shown in FIG. 6A, in which three runners A, B, and C are running in the leftward direction from the right side of an image. The rankings are: the runner A is in the lead (first place), the runner B is in third place, and the runner C is in second place.

An evaluation function l_k of a ranking k (where k is an integer from 1 to 3) is denoted by a difference between supervisory data T_k and an output value y_k of the NN. In general, it can be expressed as a function f of the following formula (1-1) that uses the ranking T_k and the output value y_k as arguments. An absolute value function, a cross-entropy function, or the like can be used as the function f. As one example, in a case where an absolute value function of a difference is used, the function f is −|y_k−T_k|. Note that the absolute value is negative because the value of the evaluation function is generally negative in this field.

As indicated by the following formula (1-2), an evaluation function L for the entire image is a function with which the evaluation functions f of rankings k are multiplied by a weight coefficient c_k and added. In the training of the NN, parameters of the NN are optimized so that the absolute value of the evaluation function L becomes small.

Note that in a case where the NN is used to track and capture the leading subject, the precision (accuracy) of inference is required to be higher for a higher ranking. In view of this, a larger weight is used for an evaluation function of a higher ranking, as indicated by the following formula (1-3), so that the evaluation function l_k of a higher ranking makes a larger contribution in the evaluation function L.

$$l\_k = f ( y\_k , T\_k ) \qquad formula ( 1 - 1 )$$

$$L = \sum c\_k * f ( y\_k , T\_k ) \qquad formula ( 1 - 2 )$$

$$c\_i \geq c\_j ( when i has higher priority than j ) \qquad formula ( 1 - 3 )$$

In a case where the weights c_k for the ranking evaluation functions l_k are constant regardless of the rankings k, the NN is trained so as to achieve the same accuracy irrespective of rankings. On the other hand, in the present embodiment, a larger weight c_k is used for a higher ranking, and thus the NN is trained so that the accuracy becomes higher for a subject of a higher ranking. Therefore, the precision of detection of the leading or first-place athlete that uses the NN can be increased.

Note that in a case where the weights corresponding to the rankings are used, it is possible to realize training that yields high accuracy for a subject of a specific ranking other than the lead or first place by increasing the weight for the specific ranking. Therefore, a subject of a desired ranking can be detected with high precision by storing the training results (parameters) that differ in the ranking with high accuracy into, for example, the ROM 155, and applying a parameter corresponding to a desired ranking to the NN.

Also, in a case where the weights corresponding to the rankings are used, the rankings of subjects to be detected can be narrowed down by setting a weight of 0 for rankings that satisfy a condition, such as the fourth place and below, for example. Furthermore, in a case where there are a plurality of subjects of the same ranking, a weight of the same value may be used in correspondence with the ranking, or a weight for one of them may be increased in accordance with a predetermined condition. For example, it is possible to increase a weight for a subject with a large head area, or a subject that is located at a short distance, within an image, from the head area of the leading subject. These are examples, and other conditions may be used. Furthermore, a plurality of conditions may be used in combination.

According to the present embodiment, a trained machine-learning model that has been trained so that the precision of detection of a subject of a specific ranking becomes higher than the precision of detection of a subject of another ranking is used as a trained machine-learning model for detecting a subject of a specific ranking from among a plurality of subjects included in an image. This makes it possible to detect a subject of a specific ranking with high precision, and to increase the precision of processing that uses a detection result of the trained machine-learning model, such as image capture with tracking.

### Second Embodiment

Next, a second embodiment of the present invention will be described. The present embodiment is different from the first embodiment in the evaluation function used in training of the NN.

The present embodiment uses an evaluation function that is based on a difference between an evaluation value of each area of a specific object detected by the NN with respect to input image data in a data set for training and an evaluation value in corresponding supervisory data, and the difference is obtained for each combination of a plurality of rankings. That is to say, although the difference is calculated for each ranking in the first embodiment, the difference is calculated for each combination of rankings in the present embodiment.

Below, the evaluation function according to the present embodiment will be further described using an example. Similarly to the first embodiment, assume a scene shown in FIG. 6A, in which three runners A, B, and C are running in the leftward direction from the right side of an image. The rankings are: the runner A is in the lead (first place), the runner B is in third place, and the runner C is in second place.

An evaluation function l_k, j of rankings k, j (1≤k, j≤3) is denoted by a deviation between supervisory data T_k, T_j of the rankings k, j and scores y_k, y_j output by the NN with respect to subjects of rankings k, j. In general, it can be expressed as a function f of the following formula (2-1) that uses the rankings T_k, j and the output values y_k, y_j as arguments. An absolute value function, a cross-entropy function, or the like can be used as the function f. As one example, in a case where an absolute value function of a difference is used, the function f is −|(y_k−y_j)−(T_k-T_j)|.

As indicated by the following formula (2-2), an evaluation function L for the entire image is a function with which the evaluation functions f of the rankings k, j are multiplied by a weight coefficient c_k, j and added. In the training of the NN, parameters of the NN are optimized so that the absolute value of the evaluation function L becomes small.

Note that in a case where the NN is used to track and capture the leading subject, the precision (accuracy) of inference is required to be higher for a higher ranking. In view of this, a larger weight is used for an evaluation function corresponding to a combination of higher rankings, as indicated by the following formula (2-3), so that the evaluation function l_k of higher rankings makes a larger contribution in the evaluation function L.

$$l\_k , j = f ( y\_k , y\_j , T\_k , T\_j ) \qquad formula ( 2 - 1 )$$

$$L = \sum c\_k , j * f ( y\_k , y\_j , T\_k , T\_j ) \qquad formula ( 2 - 2 )$$

c_k, j≥c_m, n (in a case where k is smaller than m, and in a case where the difference between k and j is larger than the difference between m and n when k=m) . . . formula (2-3)

As one example, the following is possible in the present embodiment: c_1, 2=3, c_1, 3=5, c_2, 3=1. In a case where the weights c_k, j for the evaluation functions l_k, j corresponding to combinations of rankings are constant regardless of the rankings k, j, the NN is trained so as to achieve the same accuracy irrespective of rankings.

On the other hand, in the present embodiment, the weights c_k, j increase as the difference between rankings in a combination increases, and as the combination includes a ranking closer to the lead. Therefore, the NN is trained so that the accuracy becomes higher for a combination of subjects of higher rankings. Therefore, similarly to the first embodiment, the precision of detection of the leading or first-place athlete that uses the NN can be increased.

Note that it is also possible to use the evaluation function described in the present embodiment in combination with the evaluation function described in the first embodiment. In this case, the NN is trained to update parameters so that the sum of outputs of the two evaluation functions becomes small.

### Third Embodiment

Next, a third embodiment of the present invention will be described. The present embodiment is different from the first embodiment and the second embodiment in a data set for training used in training of the NN.

Specifically, a distance to a reference position or a value based on the distance is set as supervisory data included in the data set for training. The reference position is a goal, a boundary in the moving direction in a capture range, or the like, and can be determined in advance. Also, the value based on the distance may be a score or a ranking converted from the distance. The distance may be an image distance or a real distance. In the case of a real distance, a distance actually measured may be used, or a distance obtained by simulating a captured scene through 3D modeling may be used. Furthermore, the distance may be estimated from an image of an indicator which is provided in a real space and which indicates a distance to the reference position. Note that in a case where input image data of the data set for training is generated through 3D modeling, input image data appropriate for training can be generated, and thus efficient training can be realized.

Training of the NN can be executed using the evaluation function(s) described in the first embodiment or the second embodiment, which uses a difference between distances or values based on the distances as an argument. Training is completed by optimizing parameters so that the output of the evaluation function(s) becomes smaller than a predetermined threshold.

### Fourth Embodiment

Next, a fourth embodiment of the present invention will be described. The present embodiment is different from the first embodiment and the second embodiment in a data set for training used in training of the NN.

In the present embodiment, data augmentation is applied to a data set for training. Data augmentation refers to generation of new input image data by applying such processes as rotation, inversion, masking, and cropping to another input image data included in a pre-prepared data set for training. By adding the new input image data to the data set for training together with corresponding supervisory data, generalization performance of the NN can be enhanced.

When making an addition to a data set for training through data augmentation, in a case where a part of areas of specific objects is lost as a result of processing input image data, corresponding supervisory data is modified to be in conformity with the processed input image data. For example, in a case where the areas of the specific objects are head areas, supervisory data corresponding to a head area that has been lost by a predetermined percentage (e.g., 30%) or more is deleted, and supervisory data corresponding to the rest of the head areas is modified. The modification of the supervisory data is, for example, reassignment of rankings or scores to the head areas.

FIG. 6B shows an example in which data augmentation for moving the input image data shown in FIG. 6A upward (trimming an upper portion thereof) has been applied. As shown in FIG. 6B, as a result of the data augmentation, the head area of the runner A is placed outside the cropped range (lost by 30% or more). Therefore, with respect to supervisory data corresponding to the input image data shown in FIG. 6A, the object detection unit 162 deletes data related to the head area of the runner A, and adds a modification to reassign the second place and the first place as the rankings of the runners B and C. Then, the object detection unit 162 adds the modified supervisory data to the data set for training, together with the input image data, as supervisory data corresponding to the input image data shown in FIG. 6B. Note that the lower black portion in FIG. 6B is an area that does not exist in the original input image data. A portion hidden by masking processing is similarly presented as a black area.

By using data augmentation, the time and effort required for preparation of input image data used as a data set for training can be reduced. Furthermore, supervisory data corresponding to input image data generated through data augmentation is generated by modifying supervisory data corresponding to the original input image data. Therefore, even in a case where at least a part of areas of specific objects to be detected has been lost as a result of data augmentation, learning is realized using appropriate supervisory data.

Note that the addition to the data set for training according to the present embodiment can be made in combination with the first embodiment to the third embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-030637, filed Feb. 29, 2024, which is hereby incorporated by reference herein in its entirety.

What is claimed is:

1. An image processing apparatus, comprising:
one or more processors,
wherein the one or more processors execute a program stored in a memory and thereby perform a method comprising:
obtaining image data of one frame including a plurality of subjects moving in a specific direction;
inputting the image data to a trained machine-learning model;
based on evaluation values output by the trained machine-learning model, determining rankings of the plurality of subjects in the specific direction; and
based on a result of the determination, executing processing for tracking a subject of a specific ranking, and
wherein for each of areas of the plurality of subjects, the trained machine-learning model outputs an evaluation value that increases or decreases as the ranking is closer to the specific ranking.

2. The image processing apparatus according to claim 1, wherein the trained machine-learning model has been trained so that accuracy becomes higher as the ranking is closer to the specific ranking.

3. The image processing apparatus according to claim 1, wherein
the trained machine-learning model is a trained machine-learning model that uses a neural network, and has been trained to modify parameters of the neural network so that an output of an evaluation function satisfies a convergence condition, the evaluation function using (i) an output of the neural network corresponding to input image data included in a data set for training, and (ii) supervisory data corresponding to the input image data, as arguments.

4. The image processing apparatus according to claim 3, wherein
the evaluation function is expressed as weighted addition of ranking evaluation functions, and a weight for the ranking evaluation function corresponding to the specific ranking is larger than weights for the ranking evaluation functions corresponding to other rankings.

5. The image processing apparatus according to claim 3, wherein
the ranking evaluation functions are evaluation functions of the respective rankings.

6. The image processing apparatus according to claim 3, wherein
the ranking evaluation functions are evaluation functions of respective combinations of the rankings.

7. The image processing apparatus according to claim 1, wherein
training data set used to train of the machine-learning model is composed of a pair of input image data and corresponding supervisory data, and the supervisory data is in a form of a heat map indicating a distribution of the evaluation values.

8. The image processing apparatus according to claim 1, wherein
training data set used to train the trained machine-learning model is composed of a pair of input image data and corresponding supervisory data, and the supervisory data is in a form of distances to a reference position, or values based on the distances, as the evaluation values.

9. The image processing apparatus according to claim 8, wherein
the input image data is generated through 3D modeling of a captured scene.

10. The image processing apparatus according to claim 7, wherein
the input image data includes input image data generated by processing another input image data, and supervisory data corresponding to the input image data generated by processing the other input image data is generated based on supervisory data corresponding to the other input image data.

11. The image processing apparatus according to claim 10, wherein
in a case where at least a part of an area of a subject that has been included in the other input image data is no longer included therein as a result of the processing, the supervisory data corresponding to the input image data generated by processing the other input image data is generated by modifying the supervisory data corresponding to the other input image data in response to the processing.

12. The image processing apparatus according to claim 1, wherein
the specific ranking is a first place.

13. An image capturing apparatus, comprising:
one or more processors,
wherein the one or more processors execute a program stored in a memory and thereby perform a method comprising:
generating image data of one frame with use of an image sensor;
inputting the image data to a trained machine-learning model;
based on evaluation values output by the trained machine-learning model, detecting a subject of a specific ranking from among a plurality of subjects included in the image data; and
setting a focus detection area at the detected subject of the specific ranking.

14. An image processing method executed by an image processing apparatus, the image processing method comprising:
obtaining image data of one frame including a plurality of subjects moving in a specific direction;
inputting the image data to a trained machine-learning model;
based on evaluation values output by the trained machine-learning model, determining rankings of the plurality of subjects in the specific direction; and
based on a result of the determination, executing processing for tracking a subject of a specific ranking,
wherein for each of areas of the plurality of subjects, the trained machine-learning model outputs an evaluation value that increases or decreases as the ranking is closer to the specific ranking.

15. A non-transitory computer-readable medium storing a program which, when executed by a computer, causes the computer to perform an image processing method comprising:
obtaining image data of one frame including a plurality of subjects moving in a specific direction;
inputting the image data to a trained machine-learning model;
based on evaluation values output by the trained machine-learning model, determining rankings of the plurality of subjects in the specific direction; and
based on a result of the determination, executing processing for tracking a subject of a specific ranking,
wherein for each of areas of the plurality of subjects, the trained machine-learning model outputs an evaluation value that increases or decreases as the ranking is closer to the specific ranking.
